(19) United States
(12) Patent Application Publication
(10) Pub. No.: US 2006/0190725 A1
(43) Pub. Date: Aug. 24, 2006

(54) Method and system for measuring productivity based on computer activities

(76) Inventor: Zezhen Huang, Canton, MA (US)

Correspondence Address: Zezhen Huang, 5 Beaver Brook Road, Canton, MA, 02021, US

(21) Appl. No.: 10/271,158

(22) Filed: Oct. 15, 2002

(51) Int. Cl. H04L 9/00

(52) U.S. Cl. 713/168

(57) ABSTRACT

A method and system for measuring a user's productivity for a plurality of projects conducted on computer. The system allows manager and user to define the scope of the projects in which project-related computer activities will be recorded and productivity attributes will be derived. The system receives specifications comprising a public key and identities of a plurality of computer entities associated with the projects. The computer entities may comprise a plurality of files, file directories, or network communication channels, or any combination. The system then records system activities associated with the specified computer entities, records user activities generated in any of the user controlled peripheral devices connected to the computer, determines the associations between the system activities and the user activities as well as associations between the user activities and the computer entities, derives productivity attributes from associated system activities and user activities, and encrypts the productivity attributes with the public key.

### FIELD OF INVENTION

The present invention generally relates to the field of computer software and hardware. More specifically, the present invention relates to computer activity monitoring and recording and productivity measurement systems and methods implemented in software and hardware.

### INTRODUCTION

Computer has not only become indispensable tools for many research, development and daily work, it has also become tools for shopping, reading news, watching video, sending and receiving emails for personal reasons. Therefore, knowing what employees are doing on computers has become a very important issue. Today, many companies have deployed monitoring tools to record employees' website surfing and email communications. Such monitoring tools can show how much time an employee has spent on the Internet and emails, and can serve as a warning for excessive personal usage. However, such tools cannot measure employee's productivity performed on projects or daily work, such as how much time the employee has spent on programming or writing a document. Employee's productivity is of more concern to employers.

There are existing software referred to as spy software that can record all user-activities such as every keystrokes, mouse clicks, Internet access, and email communications. Since the recording may contain all activities, it also contains activities performed on projects or daily work (work-related activities) and would allow one to derive some productivity measurement based on these activities. However, it is time consuming, if not impossible to comb through the recording to distinguish work-related and non-work-related activities and to identify activities related to specific projects. Moreover, such spy software records mostly user activities and certain Internet and email operations, it may not contain critical information about productivity related to results such as what files and how many files have been created, and how much time the user has spent on each file. Typically, such spy software operates secretly and the user has no control over what activities are being recorded. It is a strong intrusion of employee privacy and harmful to a company's culture.

The present invention measures productivity based on project oriented computer activities. Most computer-based projects or daily work would result in creation or modification of certain files or interaction with certain servers, such as creating document files, creating program language files, interacting with a database server for data entry or customer support, etc. A non-intrusive and project oriented method would be to monitor and record only those computer activities associated with a group of files and file directories or network communications that are associated with the projects. From these activities, one can then derive certain productivity attributes serving as productivity measurement.

There are some existing tools that can record computer system activities associated with certain files or network communications in a computer. For example, a file-monitoring tool may record access to a group of files and directories, a network-monitoring tool may record network communications with certain servers. However, there are drawbacks to these tools that they cannot be relied upon for productivity measurement. Firstly, certain important productivity attributes related to user activities cannot be derived from the system activities alone. For example, file system activities may show writing data blocks to a file, but they do not contain information about how long the user has spent on creating the data blocks, which is an important productivity attribute. Secondly, these tools cannot distinguish whether the system activities are caused by user operations, or by programs automatically. For example, a file-monitoring tool may record every read and write to a file and which program performs the read and write, but it cannot tell whether or not the read and write are caused by user's keyboard or mouse operations. Conceivably, a user could start a program to automatically and periodically read and write certain files to create false high productivity measurement while he or she is away from the computer or surfing the Internet. And thirdly, these tools cannot prevent a user from modifying and tampering the recorded results.

Typically, an employee would like to show high productivity and would like to have all activities related to projects or daily work been counted. An employer however, would like to ensure that the activities counted are truly performed for company's projects or daily work, not for personal benefits. For example, if a file directory is enlisted as part of a project, and all files operations under this directory are counted in productivity measurement, conceivably, an employee could create a file under this directory and create content in the file that has nothing to do with the project but for personal reason. One method of preventing such falsify action is to keep certain records on the file and/or user activities associated with the file for future review. The capability to keep records would deter an employee from working on something of personal benefits and counting them as productivity for the company. Keeping records can also protect intellectual properties as the records can serve as proof of ownership.

Although productivity measurement contains some common attributes such as time duration performed on work, user activity data rate, number of files created, etc., more accurate and complete measurement varies depending on type of the work and what results are created. Therefore, the productivity measurement system should allow an employer to define or select productivity attributes to be derived from computer activities.

For privacy and security reasons, the employer would also like to protect the measurement results from being viewed or modified by any other party.

The applicant is unaware of the existence of any tool or system that can measure productivity on a computer that contains the above features and addresses the aforementioned shortcomings in the prior art. Therefore, it is one object of the present invention to set forth a system that measures productivity based on the scope of projects and a user's project-related activities performed on a computer. Unlike spy software that secretly monitors all user's activities that may be in violation of user privacy, the present invention would allow the user and manager to define the scope of the projects or daily work for which activities and productivity will be recorded and derived. Another object of the present invention is to ensure that the measurement results are truthful and can only be viewed or processed by the manager who deploys the system. Yet another object of the present invention is to allow the manager to define or select definitions of productivity attributes that will be derived from the project-related activities. A further object of the present invention is to allow the manager to keep records or proofs of the work a user has done.

### SUMMARY OF THE INVENTION

In a preferred embodiment, the present invention provides a method and system for a manager to define a plurality of computer entities that are associated with certain projects or daily work and to derive productivity attributes from user operated computer activities associated with the computer entities. A computer entity can be a group of files or file directories, or communication channels connecting to certain servers. The present invention allows the manager to define productivity attributes for given computer entities. One special productivity attribute is keeping records of certain computer entities and related user activities to protect intellectual properties and deter intentional falsification. In the present invention, productivity attributes are encrypted with a public key such that the results can only be viewed and processed by the manager who holds a private key.

In the preferred embodiment, in the computer where productivity is to be measured, specifications comprising identities of a plurality of computer entities, productivity attribute definitions, and a public key are entered into the computer. After receiving the specifications, the productivity measurement system would record system activities that are associated with the specified computer entities, record user activities generated in any of the user controlled peripheral devices connected to the computer, determine associations between the system activities and the user activities as well as associations between some user activities and the specified computer entities. The productivity measurement system would derive specified productivity attributes from the associated system activities and user activities, and encrypt the productivity attributes using the public key. The encrypted productivity attributes are comprised in the productivity measurement result saved in files or sent over a network.

In the preferred embodiment, a user controlled peripheral device could be a keyboard, a mouse, a touch sensitive screen, a pen, a game controller, a microphone or telephone connected to the computer, or any device that is controlled by the user and connected to the computer. User activities generated in a user controlled peripheral device indicate that a user is operating the computer. Determining associations between the system activities and the user activities generated in any user controlled peripheral device is important for determining that the system activities are generated directly or indirectly by the user, not by some computer programs automatically without user operation. The associations are also important for distinguishing project-related user activities and non-project-related user activities, such that productivity can be accurately measured. In cases where system activities may not be generated within some time period following user activities, the associations between the user activities and the computer entities are determined directly. The association rules can be application dependent. For many applications, the associations can be determined based on process, thread, or Window relationships. A process is a program running in the computer, a thread is a plurality of functions running independently inside the process and a process may have multiple threads, a Window is a graphical interface interacting with the user and a thread or process may have multiple Windows. Taking process relationship as an example, if the process generating a system activity is the same process receiving a user activity, it can be determined that the system activity is caused by the user activity. Or, if the process generating the system activity communicates with the process receiving the user activity, it can be determined that the system activity is caused indirectly by the user activity. In either case, the user activity is associated with the system activity. For example, if keystrokes generated by a keyboard are received by a process, and the same process writes to a file, it can be determined that the write activities of the file are associated with the keystrokes. If a process contains multiple threads or Windows, it may be necessary to use thread or Window relationship for determining associations, similar to using process relationship described above. A time-window condition may also be applied in determining the associations, that is, a system activity and a user activity should occur within a time-window for the two activities to be associated. The length of the time window is application dependent and can be set dynamically. The time-window condition would prevent some false associations for a program that automatically generates certain system activities after some initial user inputs. The process, thread, or Window relationship can also be applied to determine the associations between the user activities and the computer entities. For example, if a Window opens a file, and the user is typing keystrokes to the Window, it can be determined that the keystroke activities are associated with the file. Once the associations are established, the system then derives the specified productivity attributes from the associated system and user activities.

In the preferred embodiment, the specified computer entities could be a group of files or file directories, a group of communication channels identified with specific server addresses or network protocols, or any combinations. For most projects or daily work performed on computer, the results are the creation or modification of certain files or file directories, or interaction with certain servers. For example, for software programming, the work is the process of creating or modifying computer language files; for sale order entry or customer support, the work is interacting with one or more database servers; and for industrial design, the work may involve creating files and interacting with servers. The specified computer entities therefore define the scope of one or more projects, on which computer activities will be recorded and productivity attributes will be derived.

The productivity attribute definitions specify what attributes will be derived from associated system and user activities as well as the computer entities. A productivity attribute specifies one aspect of the activities or computer entities. For examples, a productivity attribute could be time duration, activity data rate, or a record of certain activity or entity. All these may be important for measuring the productivity for some projects. Multiple productivity attributes can be specified for one set of computer entities.

Encrypting the measured productivity attributes with the public key ensures that no other party can view or modify the measurement result except the manager who holds the paired private key.

In one embodiment, the specifications comprising the identities of computer entities, the productivity attribute definitions, and the public key can be provided in one electronic document. And the electronic document may be contained in a digital certificate comprising a signature. The productivity measurement system can then verify the digital certificate for authenticity. Using certificate to contain the specifications ensure that no one can modify the specifications and that the author of the specifications is authenticated. In another embodiment, some specification may be omitted. For example, the productivity attribute definitions may be omitted and the productivity measurement system will automatically apply a set of productivity attribute definitions. In other embodiment, other specifications may be added. For example, the rules for determining associations between system activities and user activities as well as between user activities and computer entities can be defined and provided to the system. In the preferred embodiment, the encrypted measurement result would contain some or all of the specifications such that a system used to process the measurement result can verify the measured productivity attributes with the specifications. In another embodiment, to validate that the user has approved the measurement result, one or more digital signatures can be generated on the measured productivity attributes using a private key of the user. And the user's public key can be provided in a digital certificate such that the system used to process the measurement result can verify the user signature.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1A is a diagram of the productivity measuring system in accordance with one embodiment of the present invention;

FIG. 1B is a diagram showing some key components of a computer;

FIG. 2A, FIG. 2B, and FIG. 2C depict three examples of specifying a plurality of computer entities;

FIG. 3 is a diagram depicting the activity recording module of FIG. 1A;

FIG. 4 is a diagram depicting the flowchart of the activity association module of FIG. 1A using process relationship;

FIG. 5 depicts an example of dynamically setting time window in activity association determination;

FIG. 6 depicts an example of productivity attribute definitions;

FIG. 7 is a diagram depicting the flowchart of an exemplar attribute deriving module of FIG. 1A, in accordance with the productivity attribute definitions of FIG. 5;

FIG. 8 is a diagram depicting the flowchart of the productivity measurement result processing system in accordance with one embodiment of the present invention.

For the most part, and as will be apparent when referring to the figures, when an item is used unchanged in more than one figure, it is identified by the same alphanumeric reference indicator in the various figures in which it is presented.

### DETAILED DESCRIPTION OF THE PREFERRED EMBODIMENT

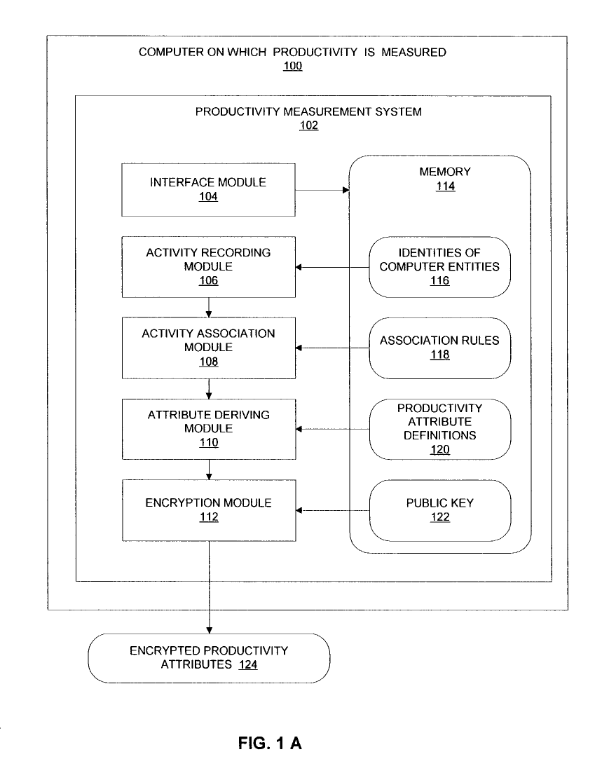

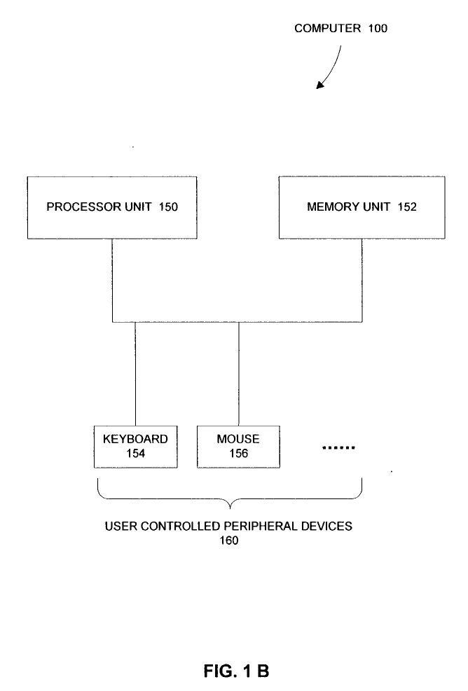

In one preferred embodiment as shown in FIG. 1A, the productivity measurement system 102 runs in a computer 100 to record productivity attributes. As shown in FIG. 1B, a computer 100 comprises a processor unit 150 for running software programs, a memory unit 152 for storing software programs and data, and one or more user controlled peripheral devices 160 such as a keyboard 154 and/or a mouse 156 for receiving user inputs. With reference to FIG. 1A, the productivity measurement system 102 is implemented as a group of modules: an interface module 104, an activity recording module 106, an activity association module 108, an attribute deriving module 110, and an encryption module 112. The interface module 104 receives specifications and saves the specifications in memory 114. The specifications comprise identities of computer entities 116, system and user activity association rule selections 118, productivity attribute definitions 120, and a public key 122. The activity recording module 106 retrieves the identities of computer entities from memory 114, records system activities in the computer's hardware or system software components comprising the specified computer entities, and filters out system activities that are associated with the specified computer entities. The activity recording module 106 also records user activities generated in any of the user controlled peripheral devices connected to the computer. The system activities and user activities are passed to the activity association module 108, which determines whether the system activities are associated with any user activities and whether some user activities are associated with any of the computer entities by employing the association rules 118. The associated system activities and the associated user activities are passed to the attribute deriving module 110, which derives the specified productivity attributes 120 from the associated system and user activities. The encryption module 112 then encrypts the productivity attributes using the public key 122. The encrypted productivity attributes 124 are comprised in productivity measurement result saved in files or sent over network to another computer.

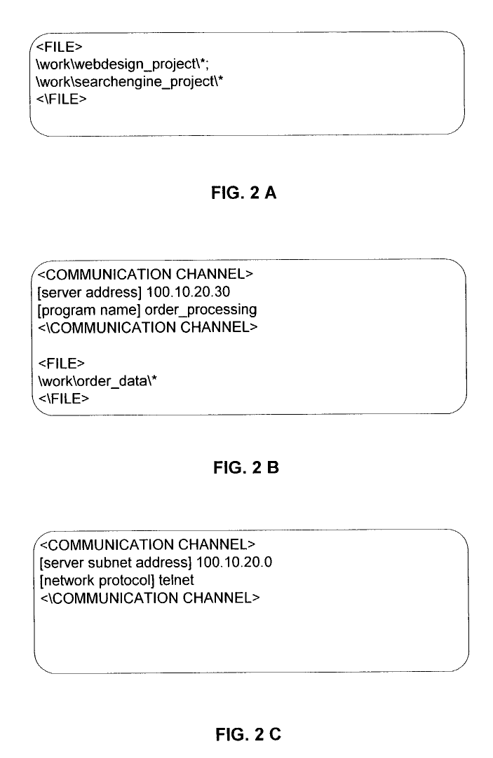

In the present invention, the identities of computer entities 116 of FIG. 1A may comprise a group of files or file directories, or a group of communication channels with specific server addresses or network protocols. The identities specify the scope of the projects or daily work for which activities are recorded and productivity attributes are derived. FIG. 2A, FIG. 2B, and FIG. 2C depict three examples of specifying identities of computer entities. FIG. 2A depicts identities for two file directories “\work\webdesign_project\*” and “\work\searchengine_project\*”. The “*” is a wildcard indicating any files or subdirectories. FIG. 2B depicts identities of a communication channel and a file directory. The communication channel is identified with server address of “100.10.20.30” and program named “order processing”. The file directory is “\work\order_data\*”. FIG. 2C depicts identities of any communication channel with server subnet address of “100.10.20.0” and network protocol of “telnet”.

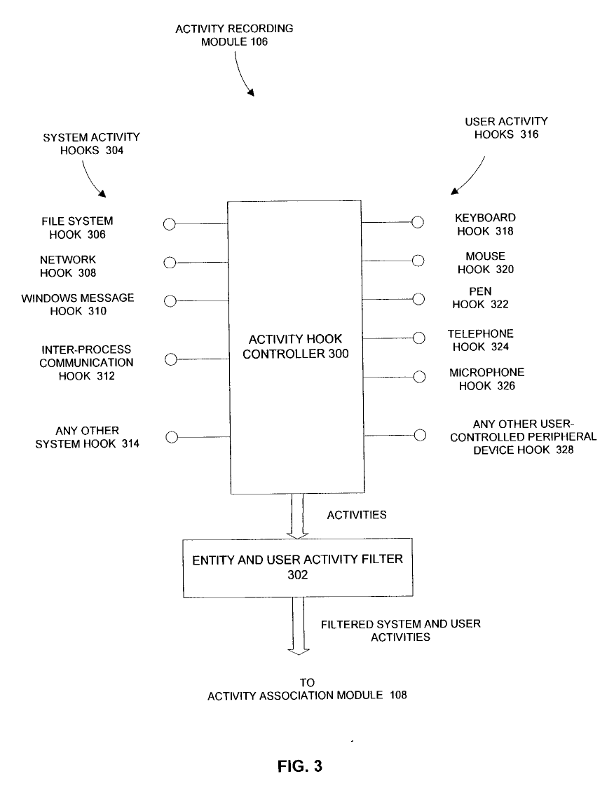

With reference to FIG. 3, the activity recording module 106 of FIG. 1A comprises an activity hook controller 300 and an entity and user activity filter 302. The activity hook controller 300 installs one or more system activity hooks 304 in accordance to the specified identities of computer entities, and also installs one or more user activity hooks 316 in the computer's user controlled peripheral devices. A hook is a software object installed in a computer's system software or hardware component to record activities associated with that component. For example, with the identities of FIG. 2A specifying two file directories, the activity hook controller 300 would install a file system hook 306 to record file system activities; and with the identities of FIG. 2B specifying a communication channel and a file directory, the activity hook controller 300 would install a network hook 308 to record network system activities and install a file system hook 306 to record file system activities. The activity hook controller 300 may also install an Windows message hook 310 and an inter-process communication hook 312 to record inter-Windows and inter-process communications activities that will be used in the activity association module 108 of FIG. 1A. With reference to FIG. 3, the entity and user activity filter 302 receives system and user activities recorded by the activity hook controller 300 and passes through all user activities, but pass through only system activities that are associated with the specified computer entities 116 of FIG. 1A. Note that most system and user activities contain parameters that directly or indirectly identify a computer entity associated the activity and the process that generates or receives the activity. For example, a file system activity would have parameters identifying the file and the process or thread that generates the activity. Some activity may not contain parameters that identify the process (or thread, or Window) receiving or generating the activity, but the identification can be derived from the current operating context. For example, a keystroke from a keyboard device may not contain the Id of the process receiving the keystroke, but the computer operating system always sends the keystroke to the current active program with the cursor focus, and therefore the receiving process Id can be derived from the current active program.

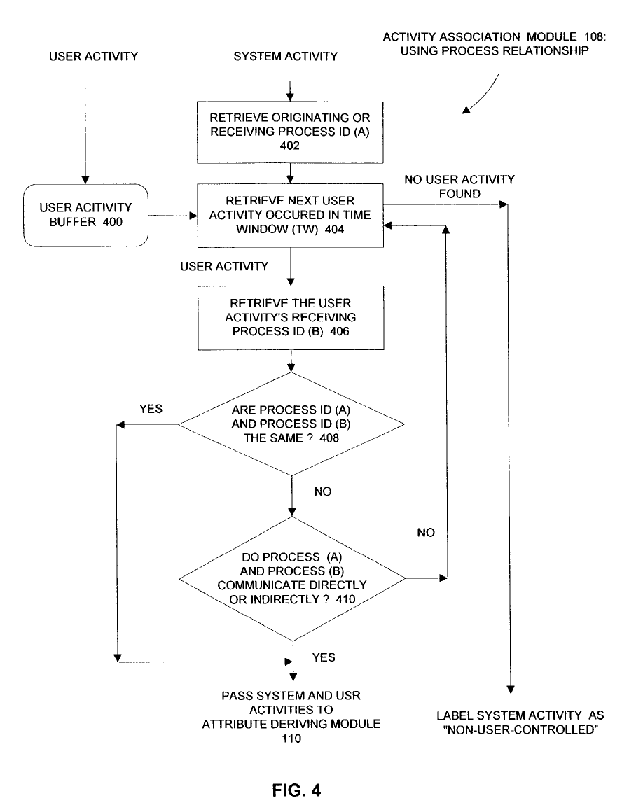

The system and user activities are then passed to the activity association module 108 of FIG. 1A, which will determine their associations. As described above for the activity recording module 106, the filtered system activities are associated with the specified computer entities. The activity association module 108 will determine whether these system activities are associated with any user activity, and whether some or all of the user activities are associated with the computer entities. A system activity is associated with a user activity if the system activity is directly or indirectly generated by the user activity within a time window. The rules used for determining associations depend on the applications and computer entities, and different rules can be employed in the present invention. The association rules could be built in the productivity measurement system or could be provided as input specification. In one preferred embodiment, the productivity measurement system has a set of association rules built in the system and allows input specification to select association rules, as shown in data block 118 of FIG. 1A. For most applications and computer entities, the association rules can be based on process, thread, or Window relationship. FIG. 4 depicts a flowchart for the activity association module 108 of FIG. 1A that uses process relationship to determine associations between system activities and user activities. With reference to FIG. 4, user activities are saved in a user activity buffer 400. For each system activity, the identity of the process (denoted as process Id (A)) that originates or receives the system activity is retrieved from parameters of the system activity in step 402. For example, for a “read to file” system activity, the Id of the process that reads the file is retrieved. In step 404, a user activity that occurs within a time window (denoted as Tw) before or after the system activity is retrieved from the user activity buffer 400, and the Id of the process (denoted as process Id (B)) that receives the user activity is retrieved in step 406. For example, for a “keystroke” user activity, the Id of the process that receives the keystroke is retrieved. In step 408, process Id (A) and process Id (B) are compared. If process Id (A) equals process Id (B), the system activity is determined to be associated with the user activity and the associated system and user activities are passed to the attribute deriving module 110 of FIG. 1A. If process Id (A) and process Id (B) are not the same, in step 410 it is further determined whether process (A) and process (B) communicate with each other directly or indirectly. The inter-process communication relationship can be determined by recording system activities with the Windows message hook 310 and inter-process communication hook 312 of FIG. 3 as described above for the activity recording module. If process (A) and process (B) interact directly or indirectly, the system activity is determined to be associated with the user activity and both activities are passed to the attribute deriving module 110 of FIG. 1A. Steps 404 to 410 are repeated for each user activity occurred in the time window Tw. If no association is found between the system activity and any user activity occurred in the time window Tw, the system activity is labeled as “non user controlled”.

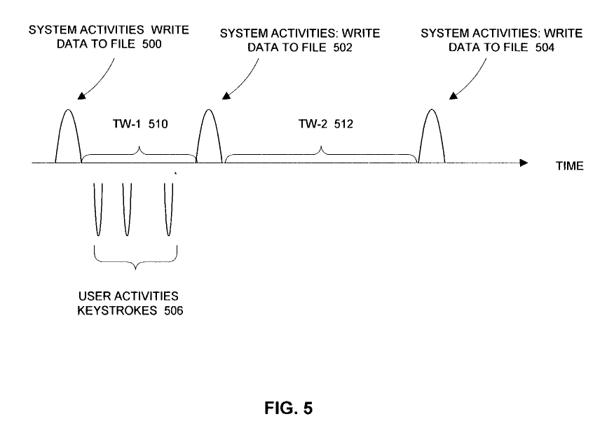

The length of the time window Tw is application dependent, and can be set dynamically. FIG. 5 depicts an example showing that the length of Tw is set dynamically for a word editor application. A word editor typically receives a sequence of user keystrokes and then saves data to the file either by user instruction or by auto-save feature. Here user activities are user keystrokes, and system activities are writing data to file. With reference to FIG. 5, three groups of system activities 500, 502, 504 represent writing data to file by the editor, and a sequence of user activities 506 represents user keystrokes. The length of time window is set as the time duration between two consecutive groups of system activities, as represented by TW-1 510 and TW-2 512, respectively. For the second group of system activities 502, the activity association module 108 of FIG. 1A would retrieve the sequence of user activities 506 occurred in the time window TW-1 510 and determine that the system activities 502 are associated with the user activities 506. For the third group of system activities 504, the activity association module 108 of FIG. 1A would find no user activity in the time window TW-2 512 and determine that the system activities 504 as “non-user-controlled”.

Since the system activities are known to be associated with the computer entities, the associations between the system activities and the user activities also mean that the user activities are associated with the computer entities. In some applications the associations between some user activities and the system activities may not be determined in some time period, and it may be necessary to determine directly whether these user activities are associated with the specified computer entities. For example, in the word editor example, if the auto-save feature is not enabled, the editor may not save data to the file for a long period of time while the user is typing keystrokes. The editor would save the keystrokes in its internal buffer until the user initiates a save command. During this period, the editor may not generate any file system activity to the file, and it may be necessary to determine whether the keystrokes are associated with the file or not. In this case, Window, thread, or process relationship can be used to determine the association. Taking the editor Window as an example, if the editor Window into which the user is typing the keystrokes has opened the file, it can be determined that the keystrokes are associated with the file. Similar relationships can be applied to determine associations when a computer entity is a network communication channel, and system activities are network communication activities.

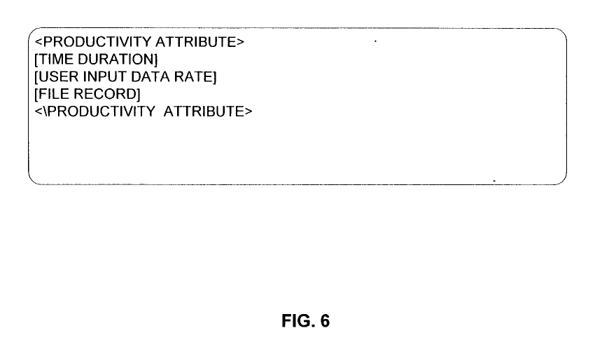

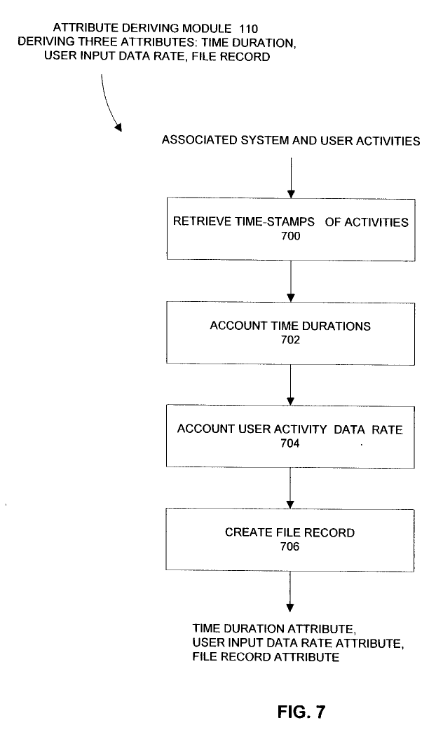

With reference to FIG. 1A, the attribute deriving module 110 derives productivity attributes from associated system and user activities. Different definitions for productivity attributes can be used depending on projects, applications, computer entities, and system and user activities. Each productivity attribute represents one aspect of the activities and the computer entities. For example, time duration attribute represents how long the user has been working on the specified computer entities; user input data rate attribute represents how many data the user has entered within a time period; and entity record attribute represents a proof of the work the user has created. Multiple attributes can be derived from the same set of activities and computer entities. In the preferred embodiment, the productivity attribute definitions are comprised in the specifications, as shown in data block 120 of FIG. 1A. FIG. 6 depicts one example of specification for three productivity attributes: time duration, user input data rate, and file record. FIG. 7 illustrates a flowchart that derives the three productivity attributes specified in FIG. 6. With reference to FIG. 7, time stamps are retrieved from each system and user activity in step 700; time durations are accounted for system and user activities in step 702; user activity data rates are accounted for user activities in step 704; and file records are created for files that have changed in step 706. Steps 702, 704, and 706 generate the three sets of attributes: time durations, user input data rates, and file records, respectively. Records for a file could be compressed or uncompressed form of the whole file or portions of the file. Records for a communication channel could be compressed or uncompressed form of the data or portions of the data sent between the program and the server. As part of productivity measurement, records serve as proof of the work the user has done. Each generated productivity attribute may comprise a plurality of parameters comprising information about identities of computer entities, identities of programs, and time periods with which the productivity attribute is associated.

Productivity attributes generated by the attribute deriving module 110 of FIG. 1A are then encrypted by the encryption module 112 of FIG. 1A. The encryption module uses the public key 122 for encryption. Public key based encryption algorithms are well-known prior art that can be found in many publications. Encrypted productivity attributes 124 are comprised in productivity measurement result that can be saved in files or sent over network to other computers for processing or viewing.

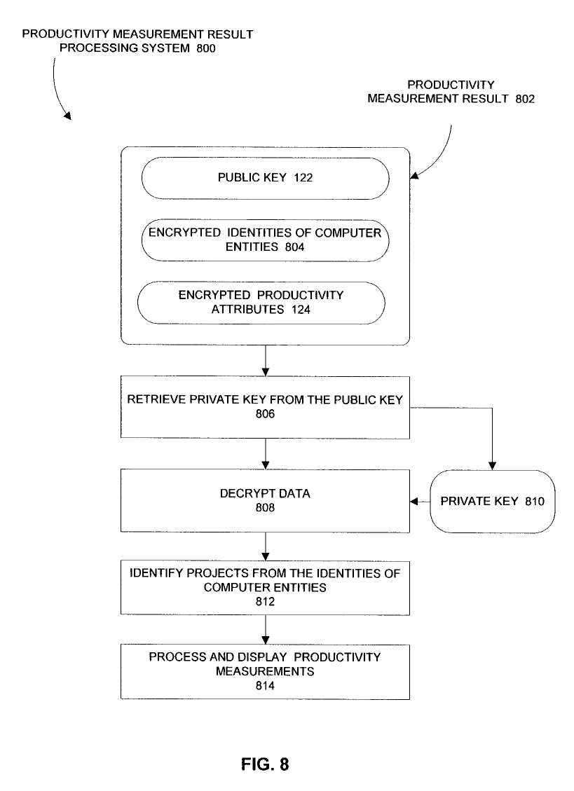

In one preferred embodiment, the productivity measurement result also comprises the specifications for the identities of computer entities and the public key, and the comprised identities of computer entities are also encrypted using the public key. The comprised public key would allow the processing system to identify the corresponding private key, and the comprised identities of computer entities would allow the processing system to identify associated projects and to associate each productivity attribute with a plurality of computer entities. The preferred productivity measurement result is depicted in data block 802 of FIG. 8.

FIG. 8 depicts the flowchart for a productivity measurement result processing system 800. With reference to FIG. 8, from the productivity measurement result 802, the system retrieves the private key 810 paired with the public key 122 in step 806, decrypts the encrypted identities of computer entities and productivity attributes in step 808, identifies the projects associated with the identities of computer entities in step 812, and then processes and displays the productivity attributes together with identities of the associated projects and computer entities.

In another preferred embodiment, the input specifications received by the interface module 104 of FIG. 1A comprising the identities of computer entities and the public key can be provided in an electronic document embedded in a digital certificate. A digital certificate is an electronic document signed by a Certificate Authority (CA). Using a digital certificate ensures that the specifications and the manager owning the public key are authenticated. In this preferred embodiment, the productivity measurement system also comprises a certificate verification module for verifying the input digital certificate. Details about digital certificate technologies can be found in many publications.

In yet another preferred embodiment, the productivity measurement result 802 of FIG. 8 can be digitally signed using a private key of the user whose productivity is being measured. The paired public key of the user can be provided in a user certificate. In this preferred embodiment, the productivity measurement system of FIG. 1 would include a signature generation module for generating user signature on the measurement result using the user private key. And the flowchart of the productivity measurement result processing system 800 of FIG. 8 would include a step to verify the user signature using the user's public key. Digitally signing the measurement result proves that the result is measured on the user. Details about digital signature and certificate can be found in many publications.

In yet another preferred embodiment where the productivity measurement result is being sent through a network communication channel to another computer, the encryption of the productivity attributes can be implemented as encryption of the network communication channel. For example, if the network communication channel is a TCP/IP connection, the encryption can be implemented by encrypting the TCP/IP connection with the public key using the Secure Socket Layer (SSL) protocol. SSL is widely used in Internet based transaction.

The invention may be embodied in other specific forms without departing from the spirit or central characteristics thereof. The present embodiments are therefore to be considered in all respects as illustrative and not restrictive, the scope of the invention being indicated by appending claims rather than by the foregoing description, and all changes that come within the meaning and range of equivalency of the claims are therefore intended to be embraced therein.

What is claimed is:

1. A method for measuring a user's productivity on a plurality of projects conducted on a computer, comprising:
A. entering specifications in said computer, said specifications comprising identities of a plurality of computer entities, each of said plurality of computer entities being associated with at least one of said plurality of projects;
B. recording system activities associated with any of said computer entities;
C. recording user activities generated in any of the user controlled peripheral devices connected to said computer;
D. determining associations between said system activities and said user activities;
E. deriving a plurality of productivity attributes from associated system and user activities;
wherein said plurality of computer entities comprise any of a group comprising:
1) a plurality of files;
2) a plurality of file directories;
3) a plurality of network communication channels.

2. The method of claim 1, wherein said specifications comprise a public key, said method further comprising:
F. encrypting said plurality of productivity attributes with said public key.

3. The method of claim 2, wherein encrypted productivity attributes are being comprised in a productivity measurement result, said productivity measurement result comprising said identities of a plurality of computer entities and said public key, said identities being used in a result processing system to identify said plurality of projects and said public key being used in said result processing system to identify a paired private key.

4. The method of claim 2, wherein said specifications are provided in an electronic document comprised in a digital certificate, said method further comprising:
G. verifying said digital certificate.

5. The method of claim 2, wherein said encrypted productivity attributes are saved in at least one file.

6. The method of claim 2, wherein step F) of encrypting said productivity attributes with said public key further comprises:
1) sending said productivity attributes through a network communication channel;
2) encrypting said network communication channel with said public key.

7. The method of claim 1, wherein said plurality of computer entities comprise a plurality of files, and wherein said system activities comprise access activities to said plurality of files, said access activities comprising any of a group comprising:
1) opening file;
2) writing to file;
3) reading from file;
4) deleting file;
5) closing file;
6) renaming file;
7) copying file.

8. The method of claim 1, wherein said plurality of computer entities comprise a plurality of network communication channels, and wherein said system activities comprise network communication activities, said plurality of network communication channels comprising any of a group comprising:
1) a TCP/IP channel;
2) a UDP/IP channel;
3) an ATM channel;
4) an Ethernet channel;
5) a frame-relay channel;
6) a telephone channel;
7) a wireless communication channel.

9. The method of claim 1, wherein said specifications comprise a plurality of productivity attribute definitions, said plurality of productivity attribute definitions being used in step E) of deriving a plurality of productivity attributes, said plurality of productivity attribute definitions comprising any of a group comprising:
1) time duration;
2) start time and end time;
3) activity data rate;
4) number of bytes entered;
5) number of database records accessed;
6) number of database records created;
7) number of files created;
8) number of files changed;
9) record of a file;
10) record of a computer activity;
11) copy of a file;
12) copy of some portions of a file;
13) compressed copy of a file;
14) compressed copy of some portions of a file;
15) record of a packet sent over a communication channel;
wherein each productivity attribute comprises a plurality of parameters comprising any of a group of information comprising:
1) identities of computer entities associated with said productivity attribute;
2) identities of programs associated with said productivity attribute;
3) time periods associated with said productivity attribute.

10. The method of claim 1, wherein step D) of determining associations between said system activities and said user activities comprises determining process relationships, step D) further comprising:
1) determining whether a process generating a system activity is the same process receiving a user activity;
2) determining whether a process generating a system activity communicates with a process receiving a user activity;
wherein said system activity is one of said system activities and said user activity is one of said user activities.

11. The method of claim 1, wherein step D) of determining associations between said system activities and said user activities comprises determining thread relationships, step D) further comprising:
1) determining whether a thread generating a system activity is the same thread receiving a user activity;
2) determining whether a thread generating a system activity communicates with a thread receiving a user activity;
wherein said system activity is one of said system activities and said user activity is one of said user activities.

12. The method of claim 1, wherein step D) of determining associations between said system activities and said user activities comprises determining Window relationships, step D) further comprising:
1) determining whether a Window generating a system activity is the same Window receiving a user activity;
2) determining whether a Window generating a system activity communicates with a Window receiving a user activity;
wherein said system activity is one of said system activities and said user activity is one of said user activities.

13. The method of claim 1, wherein step D) of determining associations between said system activities and said user activities further comprises:
1) determining whether a system activity of said system activities and a user activity of said user activities occur within a time window.

14. The method of claim 1, wherein said specifications comprise association rules, said association rules being applied in step D) of determining associations between said system activities and said user activities.

15. The method of claim 1, wherein step D) of determining associations further comprises determining associations between some of said user activities and any of said computer entities.

16. The method of claim 1, wherein step A) of entering specifications in said computer comprises any of a group of steps comprising:
1) loading from a file;
2) entering by a keyboard;
3) receiving over a network;
4) receiving over email.

17. The method of claim 1, wherein said user controlled peripheral devices comprise any of a group of devices comprising:
1) a keyboard;
2) a mouse;
3) a pen;
4) a game controller;
5) a touch sensitive screen;
6) a telephone device;
7) a microphone;
8) a wireless controlling device;
9) a computer device connecting to said computer;
and wherein said user activities comprise any of a group comprising:
1) keystrokes;
2) mouse movements and clicks;
3) pen drawing;
4) game controller clicks and movements;
5) screen touches;
6) telephone voice input;
7) microphone voice input.

18. The method of claim 2, wherein said specifications comprise a user private key, said method further comprising:
G. generating at least one digital signature on said productivity attributes using said user private key, said digital signature being used to verify authenticity of said productivity attributes and said user in a result processing system.

19. A system for measuring a user's productivity on a plurality of projects conducted on a computer, comprising:
A. an interface module, configured to receive specifications comprising identities of a plurality of computer entities, each of said plurality of computer entities being associated with at least one of said plurality of projects;
B. an activity recording module, configured to record system activities associated with any of said plurality of computer entities and record user activities generated in any of user controlled peripheral devices connected to said computer;
C. an activity association module, configured to determine associations between said system activities and said user activities;
D. an attribute deriving module, configured to derive productivity attributes from associated system and user activities;
wherein said plurality of computer entities comprise any of a group comprising:
1) a plurality of files;
2) a plurality of file directories;
3) a plurality of network communication channels.

20. The system of claim 19, wherein said specifications comprise a public key, said system further comprising:
E. an encryption module, configured to encrypt said productivity attributes with said public key.

21. The system of claim 20, wherein encrypted productivity attributes are comprised in a productivity measurement result, said productivity measurement result further comprising said identities of a plurality of computer entities and said public key, said identities being used in a result processing system to identify said plurality of projects and said public key being used in said result processing system to identify a paired private key.

22. The system of claim 20, wherein said specifications are provided in an electronic document comprised in a digital certificate, said system further comprising:
F. a digital certificate verification module, configured to verify said digital certificate.

23. The system of claim 20, wherein said encrypted productivity attributes are saved in at least one file.

24. The system of claim 20, wherein said encryption module is further configured to encrypt a network communication channel with said public key, said productivity attributes being sent through said network communication channel.

25. The system of claim 19, wherein said plurality of computer entities comprise a plurality of files, and wherein said system activities comprise access activities to said plurality of files, said access activities comprising any of a group comprising:
1) opening file;
2) writing to file;
3) reading from file;
4) deleting file;
5) closing file;
6) renaming file;
7) copying file.

26. The system of claim 19, wherein said plurality of computer entities comprise a plurality of network communication channels, and wherein said system activities comprise network communication activities, said plurality of network communications channels comprising any of a group comprising:
1) a TCP/IP channel;
2) a UDP/IP channel;
3) an ATM channel;
4) an Ethernet channel;
5) a frame-relay channel;
6) a telephone channel;
7) a wireless communication channel.

27. The system of claim 19, wherein said plurality of productivity attributes derived in said attribute deriving module comprise any of a group comprising:
1) time duration;
2) start time and end time;
3) activity data rate;
4) number of bytes entered;
5) number of database records accessed;
6) number of database records created;
7) number of files created;
8) number of files changed;
9) record of a file;
10) record of a computer activity;
11) copy of a file;
12) copy of some portions of a file;
13) compressed copy of a file;
14) compressed copy of some portions of a file;
15) record of a packet sent over a communication channel;
wherein each productivity attribute comprises a plurality of parameters comprising any of a group of information comprising:
1) identities of computer entities associated with said productivity attribute;
2) identities of programs associated with said productivity attribute;
3) time periods associated with said productivity attribute.

28. The system of claim 19, wherein activity association module is further configured to determine associations between some of said user activities and any of said plurality of computer entities.

29. The system of claim 19, wherein said determining associations between said system activities and said user activities in said activity association module comprises determining process relationships, said activity association module being further configured to determine:
1) whether a process generating a system activity is the same process receiving a user activity;
2) whether a process generating a system activity communicates with a process receiving a user activity;
wherein said system activity is one of said system activities and said user activity is one of said user activities.

30. The system of claim 19, wherein said determining associations between said system activities and said user activities in said activity association module comprises determining thread relationships, said activity association module being further configured to determine:
1) whether a thread generating a system activity is the same thread receiving a user activity;
2) whether a thread generating a system activity communicates with a thread receiving a user activity;
wherein said system activity is one of said system activities and said user activity is one of said user activities.

31. The system of claim 19, wherein said determining associations between said system activities and said user activities in said activity association module comprises determining Window relationships, said activity association module being further configured to determine:
1) whether a Window generating a system activity is the same Window receiving a user activity;
2) whether a Window generating a system activity communicates with a Window receiving a user activity;
wherein said system activity is one of said system activities and said user activity is one of said user activities.

32. The system of claim 19, wherein said activity association module is further configured to determine:
1) whether a system activity of said system activities and a user activity of said user activities occur within a time window.

33. The system of claim 19, wherein said specifications comprise association rules, said association rules being applied in said activity association module to determine associations between said system activities and said user activities.

34. The system of claim 19, wherein said interface module is further configured to receive specifications in any of a group of methods comprising:
1) receiving from a file;
2) receiving from a keyboard;
3) receiving over a network;
4) receiving over email.

35. The system of claim 19, wherein said user controlled peripheral devices comprise any of a group of devices comprising:
1) a keyboard;
2) a mouse;
3) a pen;
4) a game controller;
5) a touch sensitive screen;
6) a telephone device;
7) a microphone;
8) a wireless controlling device;
9) a computer device connecting to said computer;
and wherein said user activities comprise any of a group comprising:
1) keystrokes;
2) mouse movements and clicks;
3) pen drawing;
4) game controller clicks and movements;
5) screen touches;
6) telephone voice input;
7) microphone voice input.

36. The system of claim 19, wherein said specifications comprise a user private key, said system further comprising:
E. a digital signature generation module, configured to generate at least one digital signature on said productivity attributes using said user private key;
wherein said digital signature is used for verifying authenticity of said productivity attributes and said user in a result processing system.

37. A method for measuring a user's productivity on a plurality of projects conducted on a computer, comprising:
A. entering specifications in said computer, said specifications comprising identities of a plurality of computer entities, each of said plurality of computer entities being associated with at least one of said plurality of projects;
B. recording system activities associated with any of said computer entities;
C. recording user activities generated in any of the user controlled peripheral devices connected to said computer;
D. determining associations between said user activities and said computer entities;
E. deriving a plurality of productivity attributes from associated system and user activities;
wherein said plurality of computer entities comprise any of a group comprising:
1) a plurality of files;
2) a plurality of file directories;
3) a plurality of network communication channels.

38. The method of claim 37, wherein said specifications comprise a public key, said method further comprising:
F. encrypting said plurality of productivity attributes with said public key.

39. The method of claim 38, wherein said specifications are provided in an electronic document comprised in a digital certificate, said method further comprising:
F. verifying said digital certificate.

40. The method of claim 37, wherein said plurality of computer entities comprise a plurality of files, and wherein said system activities comprise access activities to said plurality of files, said access activities comprising any of a group comprising:
1) opening file;
2) writing to file;
3) reading from file;
4) deleting file;
5) closing file;
6) renaming file;
7) copying file.

41. The method of claim 37, wherein said plurality of productivity attributes derived in step E) comprise any of a group comprising:
1) time duration;
2) start time and end time;
3) activity data rate;
4) number of bytes entered;
5) number of database records accessed;
6) number of database records created;
7) number of files created;
8) number of files changed;
9) record of a file;
10) record of a computer activity;
11) copy of a file;
12) copy of some portions of a file;
13) compressed copy of a file;
14) compressed copy of some portions of a file;
15) record of packets sent over a communication channel;
wherein each productivity attribute comprises a plurality of parameters comprising any of a group of information comprising:
4) identities of computer entities associated with said productivity attribute;
5) identities of programs associated with said productivity attribute;
6) time periods associated with said productivity attribute.

42. The method of claim 37, wherein step D) of determining associations between said user activities and said computer entities comprises determining process relationships, step D) further comprising:
1) determining whether a process receiving a user activity is the same process generating a system activity;
2) determining whether a process receiving a user activity communicates with a process generating a system activity;
wherein said user activity is one of said user activities and said system activity is one of said system activities.

43. The method of claim 37, wherein step D) of determining associations between said user activities and said computer entities comprises determining thread relationships, step D) further comprising:
1) determining whether a thread receiving a user activity is the same thread generating a system activity;
2) determining whether a thread receiving a user activity communicates with a thread generating a system activity;
wherein said user activity is one of said user activities and said system activity is one of said system activities.

44. The method of claim 37, wherein step D) of determining associations between said user activities and said computer entities comprises determining Window relationships, step D) further comprising:
1) determining whether a Window receiving a user activity is the same Window generating a system activity;
2) determining whether a Window receiving a user activity communicates with a Window generating a system activity;
wherein said user activity is one of said user activities and said system activity is one of said system activities.

45. The method of claim 37, wherein said specifications comprise association rules, said association rules being applied in step D) of determining associations between said user activities and said computer entities.

46. The method of claim 37, wherein step A) of entering specifications in said computer comprises any of a group of steps comprising:
1) loading from a file;
2) entering by a keyboard;
3) receiving over a network;
4) receiving over email.

47. The method of claim 38, wherein said encrypted productivity attributes are saved in at least one file.

48. The method of claim 38, wherein step F) of encrypting said productivity attributes with said public key further comprises:
1) sending said productivity attributes through a network communication channel;
2) encrypting said network communication channel with said public key.

49. The method of claim 37, wherein said user controlled peripheral devices comprise any of a group of devices comprising:
1) a keyboard;
2) a mouse;
3) a pen;
4) a game controller;
5) a touch sensitive screen;
6) a telephone device;
7) a microphone;
8) a wireless controlling device;
9) a computer device connecting to said computer;
and wherein said user activities comprise any of a group comprising:
1) keystrokes;
2) mouse movements and clicks;
3) pen drawing;
4) game controller clicks and movements;
5) screen touches;
6) telephone voice input;
7) microphone voice input.
